(19) United States
(12) Patent Application Publication
(10) Pub. No.: US 2002/0077968 A1
(43) Pub. Date: Jun. 20, 2002

(54) Data sampling with priority to conforming component ratios

(75) Inventors: Yoshiyuki Kaniwa, Toyonaka-shi (JP); Kazuyori Yamamori, Toyonaka-shi (JP)

Correspondence Address: INTERNATIONAL BUSINESS MACHINES CORP, IP LAW, 555 BAILEY AVENUE , J46/G4, SAN JOSE, CA, 95141, US

(73) Assignee: International Business Machines Corporation, Armonk, NY

(21) Appl. No.: 10/015,352

(22) Filed: Dec. 12, 2001

(30) Foreign Application Priority Data
Dec. 14, 2000 (JP) 2000-380199

(51) Int. Cl. G06F 17/60

(52) U.S. Cl. 705/38

(57) ABSTRACT

A component ratio is received for a plurality of attributes associated with a composition condition. An extractable amount of data for each attribute is determined; and a target extraction amount for each attribute is calculated based, at least partially, on the component ratio. If a target extraction amount corresponding to a given attribute exceeds an extractable amount corresponding to the same given attribute, then the target extraction amount is adjusted to a value that is equal to or less than the corresponding extractable amount while retaining the component ratio within a predetermined range.

### FIELD OF INVENTION

The present invention relates to purposive sampling for randomly extracting a quantity of data from a database utilizing component ratios.

### BACKGROUND

One typical method for randomly extracting a certain amount of data from a database is random sampling wherein data is extracted from the database in random number order until a predetermined amount of data is extracted.

In a database query system, a condition that a given item has a given value may be specified wherein only the data that meets the condition is extracted. In this case again, the data (resulting data) is retrieved from a group of data items that meet the condition by using the above-mentioned random sampling.

Two methods for extracting resulting data having a certain component ratio with respect to a plurality of conditions from a database are: 1. to repeatedly change the conditions for the certain amount of data to be extracted little by little until the data having a target component ratio is found, or 2. to predetermine an extraction amount of data that meets each condition of interest in such a way that the data has the target component ratio and extract the amount of data equal to the extraction amount.

Method 1 mentioned above is a heuristic method, therefore in the worst case, all the possible combinations of data would be examined. The calculation cost would be the n^{th} power of 2 in an n-item database. Because the calculation cost increases exponentially as the number, n, increases, this method causes the Non-Polynominal (NP) problem. wherein a computer has insufficient processing capacity to cope with the calculation. Therefore, extraction of the resulting data from very large databases renders the calculation cost astronomical.

As to method 2 mentioned above, consider a case in which a certain amount, 1000 items, of data is to be randomly extracted. The composition of the data is as follows: the ratio of data having value A to data having value B with respect to condition 1 is 6:4. In this case, 600 items of data having value A and 400 items of data having value B with respect to condition 1 are extracted randomly. Then the resulting data is added together to obtain the desired resulting data.

If there are a plurality of conditions that define component ratios for the resulting data (referred to as “data having a multidimensional component ratio”), combinations of the conditions are considered and the product of component ratios of the conditions is assumed to be the amount of data to be extracted for each combined condition. For example, consider the case in which data is to be extracted wherein the ratio of data having value A to data having value B with respect to condition 1 is 6:4 and the ratio of data having value C to data having value D with respect to condition 2 is 7:3.

In this case, the following four combinations of conditions 1 and 2 are possible: AC (condition 1=A, condition 2=C), AD (condition 1=A, condition 2=D), BC (condition 1=B, condition 2=C), and BD (condition 1=B, condition 2=D).

Therefore, the following ratios among the target extraction amounts for the combinations of conditions can be provided: 42 (=6*7) items of data for AC, 18 (=6*3) items of data for AD, 28 (=4*7) items of data for BC, and 12 (=4*3) items of data for BD.

However, an extraction amount for each combined condition in multidimensional combined conditions may not be satisfied, depending upon the correlation between conditions. On the other hand, a plurality of extraction amounts may exist that satisfy a component ratio for each condition in the set of combined conditions.

For example, to extract data having the component ratio of data having value A to data having value B with respect to condition 1 is 6:4 and the ratio of data having value C to data having value D with respect to condition 2 is 7:3, the ratio between data AC, AD, BC, and BD may be 4:2:3:1 or 3:3:4:0. In the former case,

A:B=6 (=4+2):4 (=3+1) with respect to condition 1 and

C:D=7 (=4+3):3 (=2+1) with respect to condition 2.

In the latter case,

A:B 6 (=3+3):4 (=4+0) with respect to condition 1 and

C:D=7 (=3+4):3 (=3+0) with respect to condition 2.

In either case, both of the component ratios with respect to conditions 1 and 2 are met.

If the product of the component ratios for the combined conditions cannot be extracted in the ratio of

AC:AD:BC:BD=42:18:28:12

other amounts, as provided above, may be extracted.

Therefore, in order to properly perform purposive sampling for selecting resultant data having a certain multidimensional component ratio, a means is needed for adjusting the extraction amount for each combined condition in order to extract the data as close to the target component ratio as possible.

Today, financial institutions securitize money loans in order to raise funds. There are various schemes of securitizing loans. Many of them collect and pool a large number of loans and merchandise securities backed by the pool. In such a case, a set of an appropriate number of loans, extracted from the loans held by a financial institution, are securitized. The rating of the securities depends on the statistical credit risk of the loan pool. Therefore, securities having a target rating could be provided if a the component ratio of attributes of the loans under a composition condition can be established, and a set of loans that meet the component ratio can be extracted from the sets of loans held by the financial institution.

To extract the set of loans to be merchandised, a method is required for extracting resultant data having a certain component ratio with respect to a plurality of conditions from a database as described above. Furthermore, it is desirable to enable efficient purposive sampling in order to select resultant data having certain multidimensional component ratios.

### SUMMARY OF THE INVENTION

To overcome the limitations in the prior art briefly described supra, the present invention provides a process, system or computer-readable medium for extracting a set of data from a population data group. In one embodiment of the invention a component ratio is received for a plurality of attributes associated with a composition condition. An extractable amount of data for each attribute is determined; and a target extraction amount for each attribute is calculated based, at least partially, on the component ratio. If a target extraction amount corresponding to a given attribute exceeds an extractable amount corresponding to the same given attribute, then the target extraction amount is adjusted to a value that is equal to or less than the corresponding extractable amount while retaining the component ratio within a predetermined range.

In another embodiment of the invention a component ratio is received for each of a plurality of composition conditions. An extractable amount for each attribute value combination in the plurality of composition conditions is determined; and a target extraction amount for each attribute value combination is calculated. A subset of these target extraction amounts are then adjusted utilizing a diagonal replacing adjustment operation wherein the target extraction amount is less than or equal to the extractable amount for each attribute value combination and said component ratios are retained within a predetermined range.

In still another embodiment of the invention, a data manipulation method is performed by a data processing apparatus for sampling a population data group with a plurality of composition conditions, including a plurality of component ratios. Association data, comprising at least a target extraction amount for each attribute value combination in the composition conditions, are adjusted without changing the component ratios. Four attributes, two attributes from each of two composition conditions, are selected to provide four attribute value combinations of two each of these four attributes. A first combination, having a first attribute and a second attribute are selected from the four attribute value combinations. A second combination, with a third and fourth attribute, is determined by selecting the attribute value combination with attributes that are different from the first and second attribute. A predetermined value is subtracted from each of the target extraction amounts in the association data associated with the first combination and the second combination. This same predetermined value is added to the target extraction amounts in the association data associated with a third and fourth combination. This third and fourth combination are the remaining two combinations from the four attribute value combinations after excluding the first and second combinations.

In yet another embodiment of the invention, a population data group comprises loan information. This loan information is extracted in accordance with calculated target extraction amounts, whereby a group of loans to be merchandised are identified.

Further, a novel method is disclosed for selecting items of loan information from a population data group residing in a sampled population database. These selected items of loan information form a pool of loans to be securitized and a credit risk is established for the pool. A sampling condition, comprising multi-dimensional component ratios, is provided in accordance with the established credit risk. This sampling condition further comprises a total extraction amount representing the desired number of items of loan information to be included in the pool of loans. A diagonal replacing adjustment database is utilized for the selection of items of loan information whereby a pool of loans is formed in accordance with the credit risk and comprises a number of items of loan information that is equal to or less than the total extraction amount.

In addition, the present invention may be provided as a database system for implementing the above-described data sampling method. The present invention may also be tangibly embodied in and/or readable from a computer-readable medium containing program code (or alternatively, computer Instructions). Program code, when read and executed by a computer system, causes the computer system to perform the above-described data sampling method.

Various advantages and features of novelty, which characterize the present invention, are pointed out with particularity in the claims annexed hereto and form a part hereof. However, for a better understanding of the invention and its advantages, reference should be made to the accompanying descriptive matter, together with the corresponding drawings which form a further part hereof, in which there is described and illustrated specific examples of preferred embodiments in accordance with the present invention.

### BRIEF DESCRIPTION OF THE DRAWINGS

FIG. 1 is a diagram for illustrating a general configuration of a database system in accordance with the preferred embodiment;

FIG. 2 is a flowchart illustrating a data sampling operation in accordance with the preferred embodiment and describing an operation for creating association data in which a target extraction amount is associated with an extractable amount for each attribute value in each composition condition;

FIG. 3 is a flowchart illustrating a data sampling operation in accordance with the preferred embodiment and describing an operation for creating association data in which a target extraction amount is associated with an extractable amount for each attribute value combination;

FIG. 4 is a flowchart illustrating a data sampling operation in accordance with the preferred embodiment and describing an operation for determining the points on which diagonal replacing adjustment is performed;

FIG. 5 is a flowchart illustrating a data sampling operation in accordance with the preferred embodiment and describing the diagonal replacing adjustment operation;

FIG. 6 is a flowchart illustrating a data sampling operation in accordance with the preferred embodiment and describing an operation for recursively performing the diagonal replacing adjustment on data for all the attribute value combinations;

FIG. 7 is a flowchart illustrating a data sampling operation in accordance with the preferred embodiment and describing an operation for extracting data from a population data group;

FIG. 8 is a diagram showing an example of a sampling condition comprising a total extraction amount and component ratios in accordance with the preferred embodiment;

FIG. 9 is a diagram showing an example of association data in which a target extraction amount is associated with an extractable amount for each composition condition and attribute value;

FIG. 10 is a diagram showing the association data after the association data in FIG. 9 is adjusted;

FIG. 11 is a diagram showing association data in which a balance proportion is associated with a target extraction and extractable amount for each attribute value combination shown in FIG. 10;

FIG. 12 is a diagram illustrating the fundamental concept the diagonal replacing adjustment operation in accordance with the preferred embodiment;

FIG. 13 is a diagram showing the association data in FIG. 11 as a three-dimensional space having the composition conditions as the coordinate axes;

FIG. 14 is an diagram showing the three-dimensional space of FIG. 13 after the diagonal replacing adjustment operation is performed;

FIG. 15 is a diagram showing the three-dimensional space of FIG. 14 after the diagonal replacing adjustment operation is further performed;

FIG. 16 is a diagram showing the three dimensional space of FIG. 15 after the diagonal replacing adjustment operation is further performed;

FIG. 17 is a diagram showing association data after the diagonal replacing adjustment operation processes shown in FIG. 13 through FIG. 16 is performed for each attribute value combination shown in FIG. 11;

FIG. 18 is a diagram showing the three-dimensional space of FIG. 16 after the diagonal replacement adjustment operation is performed;

FIG. 19 shows a comparison of target extractions before and after the diagonal replacing adjustment operation shown in FIG. 13 through FIG. 18 is performed for each attribute value combination shown in FIG. 11;

FIG. 20 is a table listing key data obtained from the population data group and extraction amounts in accordance with the preferred embodiment; and

FIG. 21 is a table listing the key data shown in FIG. 20 reordered randomly.

### DESCRIPTION OF THE PREFERRED EMBODIMENTS

The preferred embodiments, in accordance with the present invention and shown in the accompanying drawings, is directed to a method for extracting a set of data from a population data group The following description is presented to enable one of ordinary skill in the art to make and use the present invention and is provided in the context of a patent application and its requirements. Various modifications to the preferred embodiments will be readily apparent to those skilled in the art and the teaching contained herein may be applied to other embodiments. Thus, the present invention should not be limited to the embodiments shown but is to be accorded the widest scope consistent with the principles and features described herein.

Referring to FIG. 1, a general configuration of a database system comprises a sampling condition input section 10 for inputting a sampling condition for extracting desired data from a database; a data processing section 20 for performing processes such as data sampling and the manipulation of sampling conditions; status-by-condition storage 30 for storing data generated and/or used by the data processing section 20; status-by-attribute-value-combination storage 40; random-order-key storage 50; a sampled population database 60 for storing a group of data (hereinafter called “population data group”) which is the target of sampling processes; a sampling result database 70 for storing a group of data (herein after called “resulting data group”) extracted from the population data group during sampling processes; a database management section 80 for managing the sampled population database 60 and the sampling result database 70; and an output section 90 for outputting the resulting data group stored in the sampling result database 70.

The sampling condition input section 10 in FIG. I may be implemented by an input device, such as a keyboard and mouse, operatively coupled to a display device for displaying an entry screen, and an input/output interface. A sampling condition for retrieving a resulting data group from the population data group is input into the sampling condition input section 10. The sampling condition input section 10 may be configured so as to accept input from an external device over a network or may be an interactive input means for inputting an SQL query.

The data processing section 20 may be implemented by a central processing unit (CPU) controlled by a program, random access memory (RAM), and other memory. The data processing section 20, in accordance with the preferred embodiment, determines an amount of data to be extracted based on a sampling condition input through the sampling condition input section 10 and the data organization of the population data group stored in the sampled population database 60; extracts data from the population data group based on the determined data amount; and, in response to a data retrieve request from an external source, reads a resulting data group stored in the sampling result database 70 to output it through the output section 90.

The status-by-condition storage 30 may be implemented, for example, by semiconductor memory or a magnetic storage device and stores association data. Association data comprises amounts of data to be extracted for attribute values (hereinafter called “target extraction amount”) for each sampling condition input through the sampling condition input section 10 wherein each extraction amount is paired with the corresponding amount of data that can be extracted (hereinafter called “extractable amount”) from the population data group. The association data is generated in the data processing section 20 and stored in the status-by-condition storage 30.

The status-by-attribute-value-combination storage 40 may be implemented, for example, by semiconductor memory or a magnetic storage device and stores association data of a target extraction amount with an extractable amount for each combination of composition conditions input through the sampling condition input section 10. This association data is generated in the data processing section 20 and stored in the status-by-attribute-value-combination 40.

The random-order-key storage 50 may be implemented, for example, by semiconductor memory or a magnetic storage device and temporarily stores the extracted resulting data when the data is extracted from the population data group.

The sampled population database 60 may be implemented, for example, by semiconductor memory or a magnetic storage device and stores a population data group to be sampled. The sampling result database 70 may be implemented, for example, by semiconductor memory or a magnetic storage device and stores a resulting data group extracted from the population data group. The database management section 80 may be implemented, for example, by a program-controlled CPU, RAM and other memory and manages accesses (data input and output) to the sampled population database 60 and the sampling result database 70. The output section 90 may be implemented, for example, by an output device such as a display device or printer operably coupled to an input/output interface, and outputs the resulting data group stored in the sampling result database 70. The output section 90 may be configured so as to output the resulting data group to an external device over a network.

The program code (or alternatively, computer instructions) for controlling the CPU to implement the data processing section 20 and the database management section 80 may be provided by storing it on a computer-readable medium. The program code, when read and executed by a computer causes the computer to perform the process steps for the data sampling method described infra in accordance with the preferred embodiment. Thus, a preferred embodiment of the present invention may be implemented as process steps (also known as a method), a computer system, or an article of manufacture using standard programming and/or engineering techniques to produce software, firmware, hardware, or any combination thereof. The term “article of manufacture” (or alternatively, “computer program product”) as used herein is intended to encompass program code accessible from any computer-readable device, carrier, or media. Examples of a computer-readable device, carrier or media include, but are not limited to, palpable physical media such as a CD ROM, diskette, hard drive and the like, as well as other non-palpable physical media such as a carrier signal, whether over wires or wireless, when the program is distributed electronically.

A data sampling method in accordance with the preferred embodiment is described below.

A data sampling condition, input to data processing section 20, comprises data composition conditions and corresponding component ratios. A component ratio is the ratio of data having a predetermined value (hereinafter called “attribute value”) to the entire resulting data group generated under the composition condition. Utilizing this input, individual items of data that meet the conditions are randomly retrieved from the population data group wherein the resulting data group is formed.

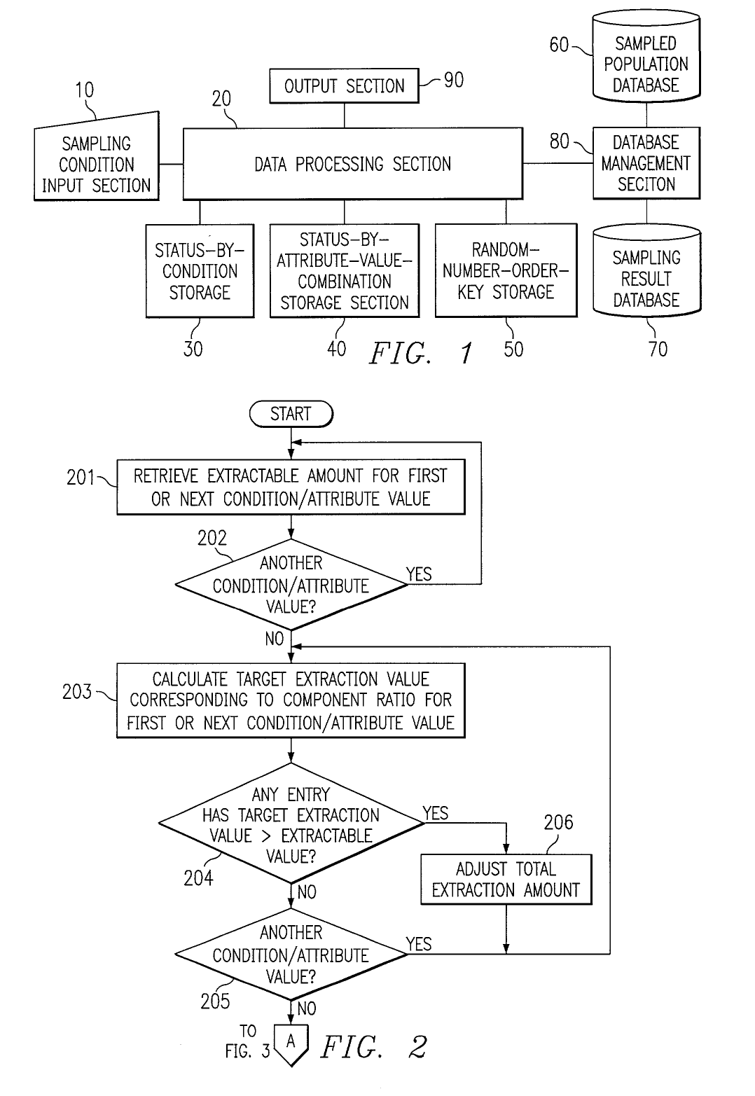

FIG. 2 through FIG. 7 show flowcharts which, in conjunction with the diagrams shown in FIG. 8 through FIG. 21, illustrate the operations of data sampling in accordance with the preferred embodiment.

As an initial operation, a sampling condition, shown in FIG. 8, is input through the sampling condition input section 10 into the database system to request data sampling. In this case, it is assumed that the population data group consists of 10,000 items of data. Referring to FIG. 8, the number of items, 1000 is specified as the entire extraction amount and three conditions, A, B, and C, are specified as composition conditions. In addition the sampling condition shown in FIG. 8 specifies that the component ratio of data having attribute value A1 to data having attribute value A2 is 4:6 with respect to composition condition A; the component ratio among data having attribute value B1, B2, and B3 is 2:3:5 with respect to condition B; and the component ratio between data having attribute value C1 and data having attribute value C2 with respect to condition C is 5:5 (the component ratios in the composition conditions are represented in percentages in FIG. 8).

When the data sampling request is input, the data processing section 20 first determines the extractable amount for each attribute value specified in the composition conditions (step 201 in FIG. 2). The extractable amount can be determined by requesting the number of data items actually contained in the population data group, with attribute values matching the composition conditions, from the database management section 80 by means of a SQL query. This extracting operation is repeated until the extractable amounts for all of the attribute values for each composition condition are obtained (step 202).

The data processing section 20 then calculates a target extraction amount corresponding to the component ratio for each attribute value (step 203). The target extraction amount is obtained by multiplying the total extraction amount by the component ratio for the attribute value in each composition condition. For example, referring to FIG. 8, it is specified in construction condition A that 40% of data having attribute value A1 and 60% of data having attribute value A2 are extracted. The total extraction amount, 1,000, is multiplied by the respective component ratio, yielding the target extraction amount, 400, for data having attribute value A1 and 600 for data having attribute value A2.

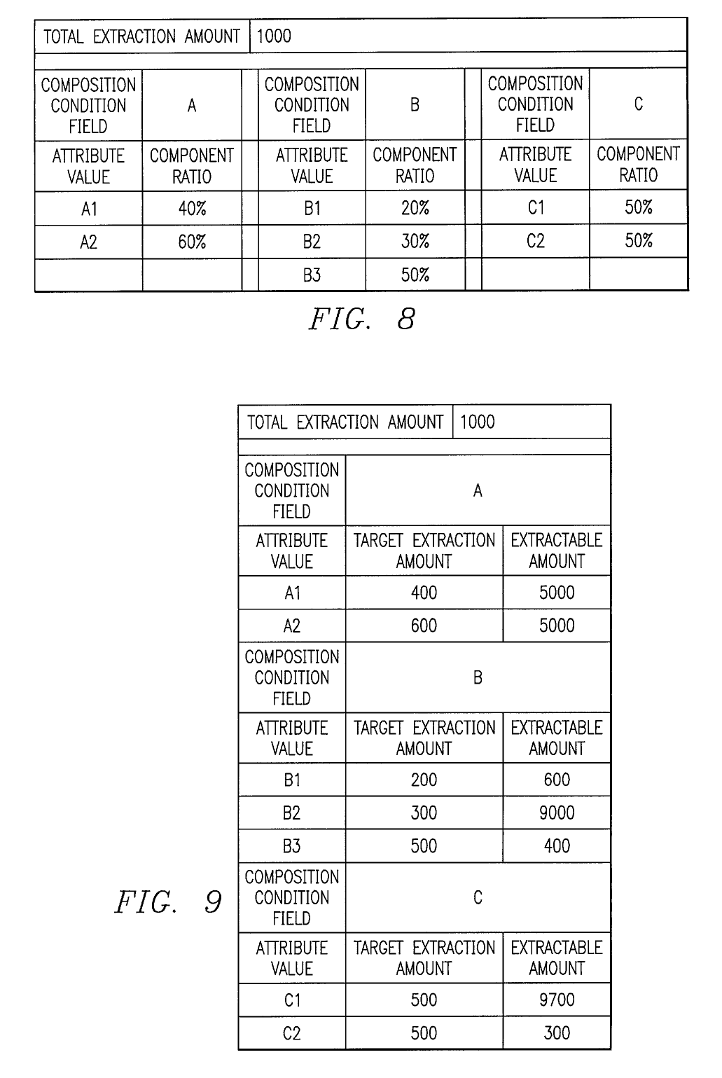

FIG. 9 shows an example of association data. This data represents the target extraction amount with extractable amount for each composition condition and attribute value. The association data is stored in the status-by-condition storage 30. As shown in FIG. 9, the extractable amounts for the respective attribute values in the respective composition conditions in 10,000 items of data in the population data group in this example are: 5,000 items for each of attribute values A1 and A2 classified under condition A, 600 items for attribute value B1, 9000 items for attribute value B2, and 400 items for attribute value B3 classified under condition B, and 9700 items for attribute value C1 and 300 items for attribute value C2 classified under condition C.

Then the data processing section 20 compares the target extraction amount with the extractable amount for each attribute value in the association data shown in FIG. 9 to determine whether there is any entry in which the target extraction amount is larger than the extractable amount (step 204). The calculation of a target extraction amount and the comparison between the calculated target extraction amount and extractable amount are repeated until target extraction values for all the composition conditions and attribute values in the input sampling condition are obtained (step 205).

If there is an entry in which its target extraction amount is larger than its extractable amount at step 204, the target extraction amount cannot be reached even if all the extractable amount of data is extracted. Therefore, in order to extract a resulting data group with a data composition that meets the sampling condition, the total extraction amount is reduced so that the target extraction amounts for all the entries becomes equal to or less than their extractable amounts. In particular, a new total extraction amount is defined by the following equation (step 206):

new total extraction amount=(previous total extraction amount)*(extractable amount/target extraction amount)

Then a target extraction amount is recalculated based on the new total extraction amount obtained.

In the example shown in FIG. 9, the target extraction amounts are larger than the extractable amounts for attribute value B3 in composition condition B and for attribute value C2 in composition condition C. Therefore, the total extraction amount is reduced to 600 (=1000*(300/500)) so that the target extraction amounts are less than the extractable amounts in these entries.

In this way, a resulting data group can be obtained that complies with the component ratio for attributes in each composition condition by readjusting the total extraction amount for the corresponding input sampling condition. However, while the input sampling condition for the component ratio of attributes in each composition condition can be met by this adjustment, the total extraction amount will fall short of the extraction condition. Therefore, the determination at step 204 and the adjustment of the total extraction amount at step 206 may be eliminated in a process where the quantity of extracted samples in a resulting data group is more important than the component ratio of attributes in each composition condition. In an alternative embodiment, the adjustment of the total extraction amount at step 206 may also be eliminated if the component ratio is retained within a predetermined range prior to performing the adjustment.

FIG. 10 shows association data of target extraction amounts with extractable amounts after the adjustment described supra for step 206. Note that target extraction amounts for both of the attribute values B3 and C2 are now less than their extractable amounts. The recalculated association data is stored in the status-by-condition storage 30, replacing the association data (shown in FIG. 9) previously stored in the status-by-condition storage 30.

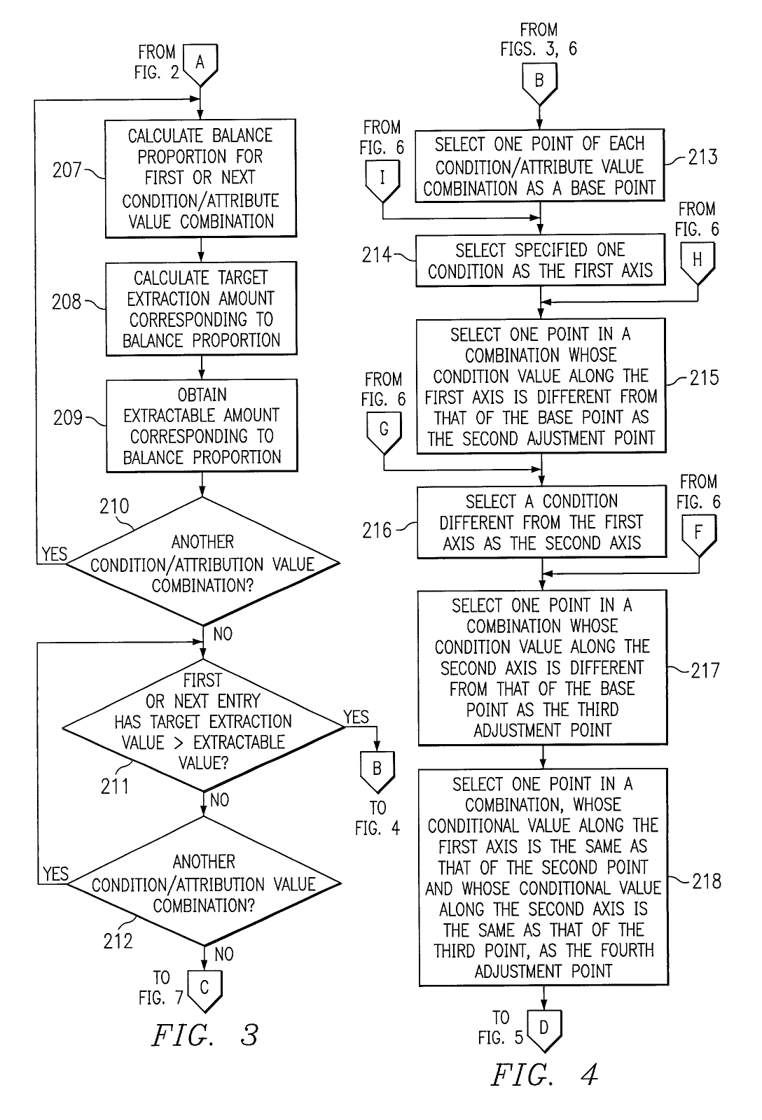

Then the data processing section 20 obtains a combination of attribute values (hereinafter called “attribute value combination”) for the composition conditions A, B, and C. A balanced proportion for each attribute value combination is then calculated, along with the corresponding target extraction amount, in accordance with the calculated balanced proportion, and the corresponding actual extractable amount from the population data group (steps 207, 208, and 209 in FIG. 3). The balance proportion herein is the product of component percentages for respective attribute values in each attribute value combination. For example, the balance proportion for the combination of attribute values A1, B1, C1 is as follows:

40%*20%*50%=4%.

The target extraction amount is calculated by multiplying the total extraction amount by the balance proportion of each attribute value combination. The extractable amount can be determined by inquiring the actual number of items of data in the population data group from the database management section 80 by using a SQL query.

The operation for obtaining the above-mentioned information is repeated until information with respect to all the composition conditions and attribute value combinations is obtained (step 210).

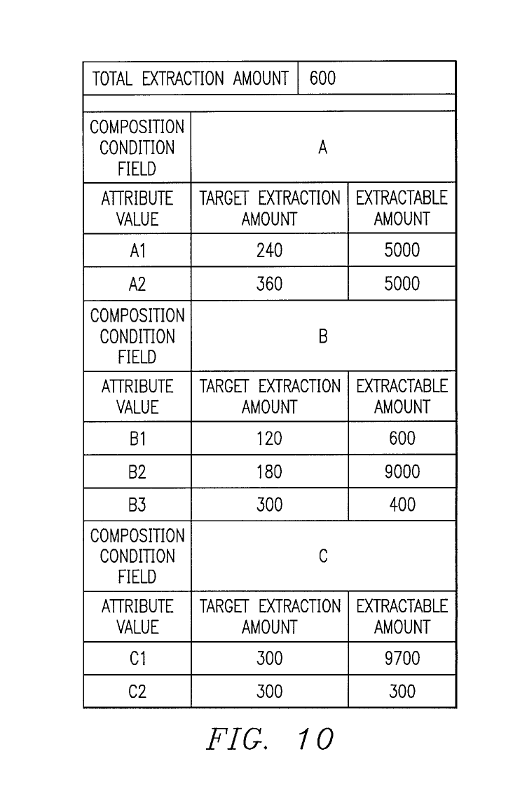

FIG. 11 shows association between the balance proportion, target extraction amount, and extractable amount for each attribute value combination calculated based on the association data shown in FIG. 10. The association data shown is stored in the status-by-attribute-value-combination storage 40. The total extraction amount in FIG. 11 can be obtained from the association data stored in the status-by-condition storage 30.

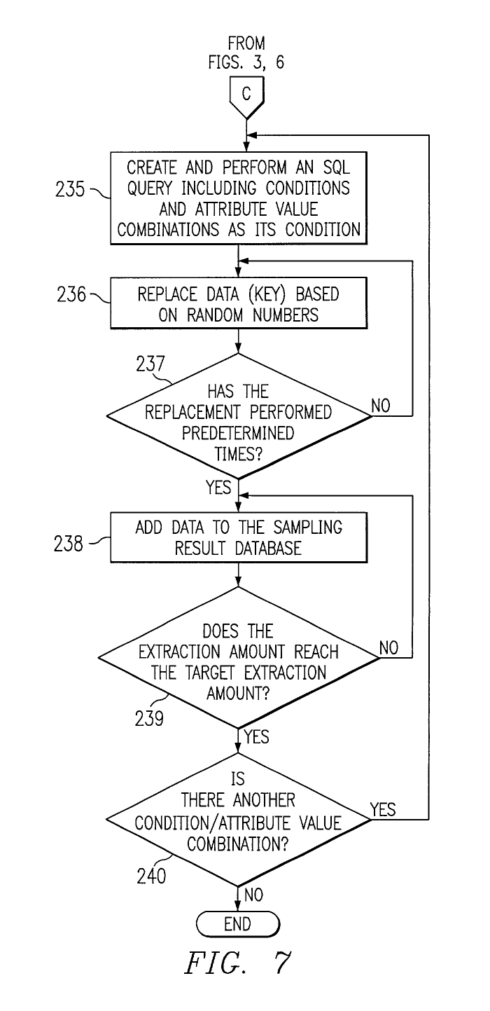

Then, the data processing section 20 compares the target extraction amount with the extractable amount for each attribute value combination in the association data shown in FIG. 11 to determine whether there is any entry in which the target extraction amount is larger than the extractable amount (step 211). If the target extraction amounts are equal to or less than the extractable amounts in all the entries (step 212), the process proceeds to the step 235 and subsequent steps shown in FIG. 7 for actually extracting the data from the population data group.

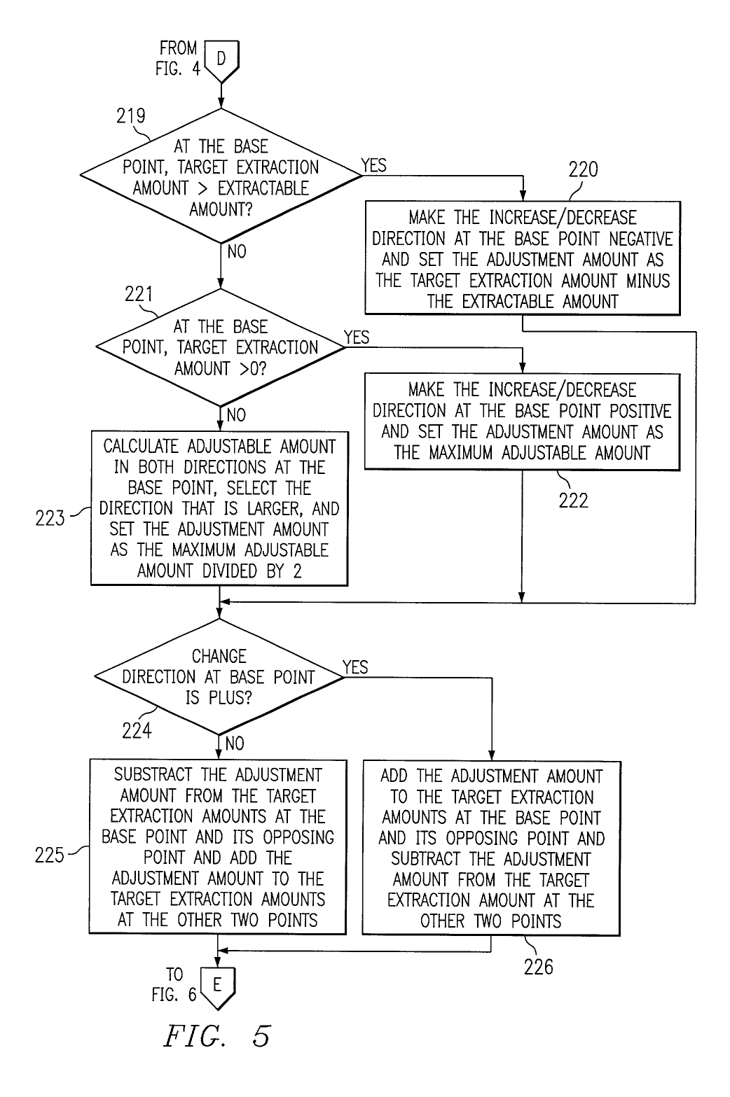

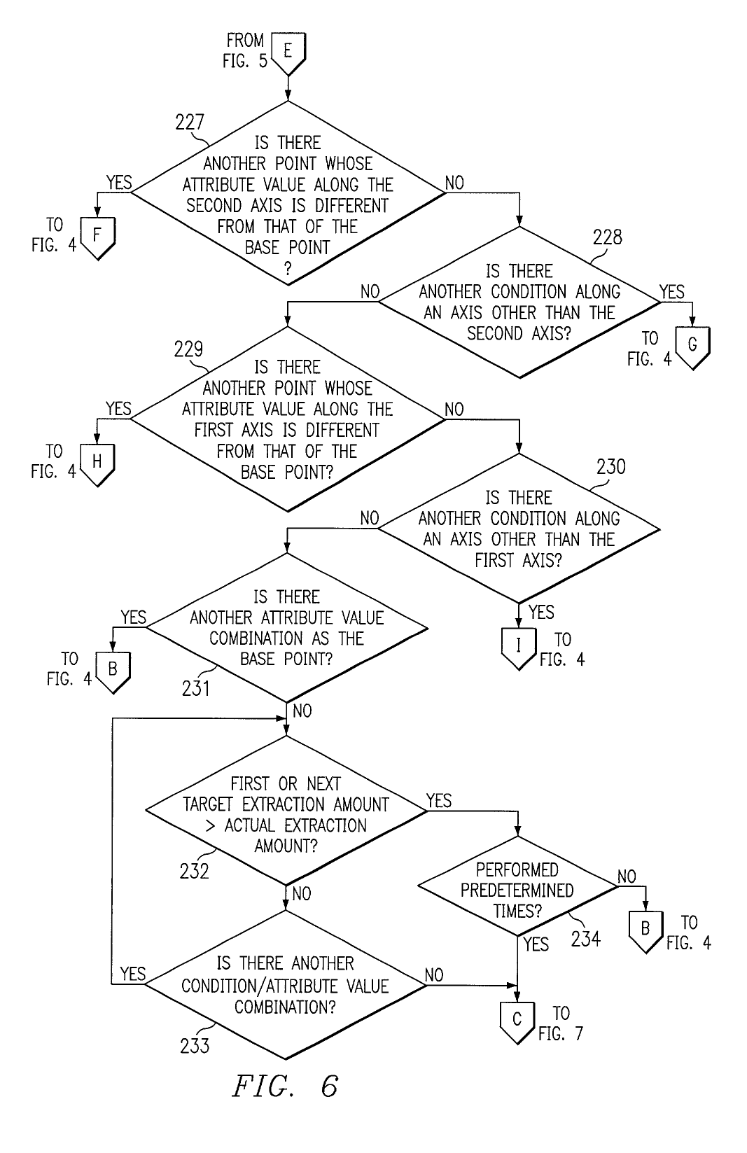

If there is an entry in which the target extraction amount is larger than the extractable amount, then a diagonal replacing adjustment is performed (beginning with step 213, FIG. 4) on the target extraction amounts by using the association data between the target extraction amount and the extractable amount in each attribute value combination shown in FIG. 11.

Referring now to the data group shown in FIG. 12A and 12B, the basic concept of the diagonal replacing adjustment is described. The data group corresponds to two composition conditions, conditions ″ and S (that is, it has a two-dimensional component ratio). Condition ″ has three attribute values, ″1, ″2, and ″3, and condition $ has two attribute values, $1 and $2. FIG. 12A shows the state before the diagonal replacing adjustment is performed and FIG. 12B shows the state after the diagonal replacing adjustment is performed.

Consider a rectangle consisting of four cells of attribute value combinations ″1$1, ″2$1, ″1$2, and ″2$2 in the data group shown in FIG. 12A. If a predetermined value is added to the values in two cells located in the predetermined opposing corners of the rectangle and the same value is subtracted from the values in the other two cells, the one-dimensional component ratio of each composition condition is not changed, as shown in FIG. 12B. Such an operation is called “diagonal replacing adjustment.”

Referring to FIG. 12A and 12B, the diagonal replacing adjustment is described in detail. In FIG. 12A, a value, 2, is added to the value (16) in the cell of attribute value combination ″1$1 and to the value (18) in the cell of attribute value combination ″2$2 located in the opposing corner, and the same value, 2, is subtracted from the values (12, 24) in the other cells. Even after this diagonal replacing adjustment is performed, the total value (40) of the data having attribute value ″1, the total value (30) of the data having attribute value ″2, the total value (40) of the data having attribute value $1, and the total value (60) of the data having attribute value $2 are not changed as shown in FIG. 12B.

Such a relation always holds for the four cells in the two pairs of opposing corners in a rectangle arbitrarily assumed in a data group having a two-dimensional component ratio as shown in FIG. 12A and FIG. 12B. A database system for extracting data from a population data group utilizing the diagonal replacing adjustment described supra is also referred to as a diagonal replacing adjustment database system.

The diagonal replacing adjustment can also be performed on a data group having a greater than two-dimensional component ratio by focusing on any one two-dimensional composition condition in the data group. That is, the two-dimensional composition condition to be processed can be exclusively addressed by ignoring composition conditions other than the two-dimensional composition condition currently being processed. This means that an n-dimensional space having n composition conditions as its coordinate axes is provided (each point in the space corresponds to each attribute value combination), then the n-dimensional space is cut through by a two-dimensional plane (coordinate plane), and the diagonal replacing adjustment is performed on that two-dimensional plane.

The data processing section 20 performs the above-described diagonal replacing adjustment on the association data as shown in FIG. 11 to adjust the target extraction amount without changing the one-dimensional component ratios.

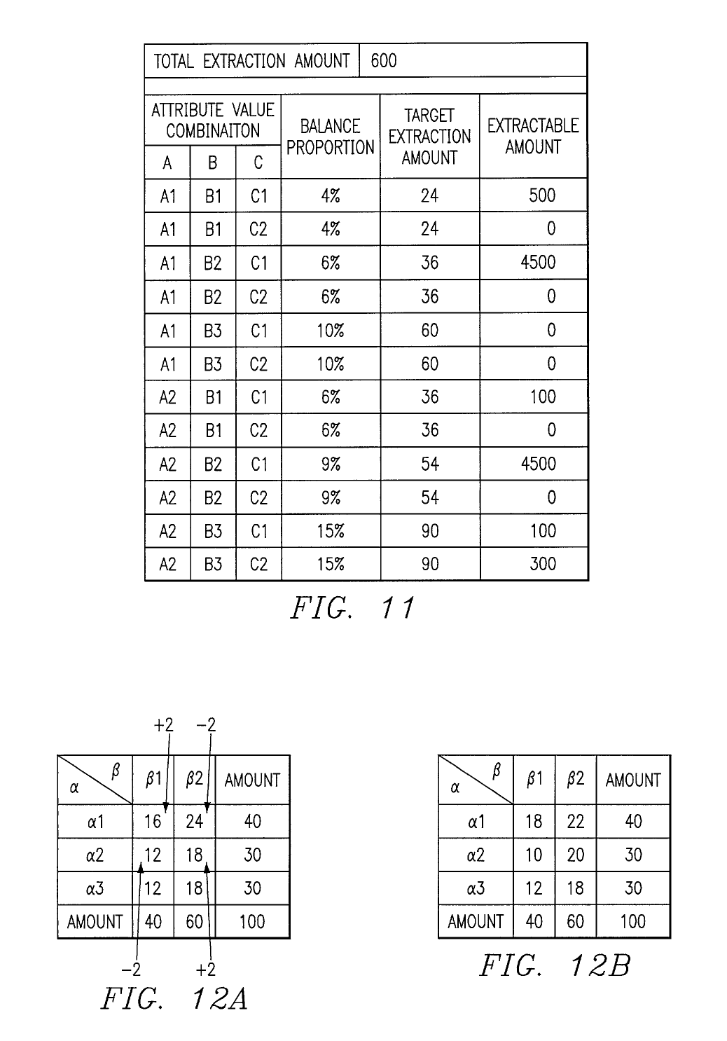

FIG. 13 is a diagram showing an image in which the association data shown in FIG. 11 is depicted as an n-dimensional (in this case three-dimensional) space with composition conditions as its coordinate axes. In FIG. 13, composition condition A is represented by two rows and composition conditions B and C are represented by the vertical axis and horizontal axis of the diagram, respectively,

The data processing section 20 assumes a given point (one cell) in the association data shown in FIG. 13 as the base point (step 213 in FIG. 4). The base point is one of the cells on which the diagonal replacing adjustment is performed. Then a predetermined one of the composition conditions is assumed as the first axis (coordinate axis) in the two-dimensional plane (coordinate plane) (step 214). A point (cell) whose attribute values except one along the first axis are the same as those of the base point is selected as an object cell for diagonal replacing adjustment (step 215).

Then a given one of composition conditions that is different from the first axis is selected as the second axis orthogonal to the first axis in the two-dimensional plan (step 216). A point (cell) whose attribute values except one along the second axis are the same as those of the base point is selected as an object cell for diagonal replacing adjustment (step 217).

Finally, one point (cell) whose attribute value along the first axis is the same as that of the point selected at step 215, whose attribute value along the second axis is the same as that of the point selected at step 217, and whose other attribute values are the same as those of the base point is selected as an object cell for diagonal replacing adjustment (step 218).

The four cells selected in this way form the opposing corners of a rectangle, which is the object for the above-describe diagonal replacing adjustment in the two-dimensional plane. While in this example the four cells form a rectangle because the two axes are orthogonal to each other, in general they may form a parallelogram.

In this example, one base point (cell) is selected and then the other three cells are selected by using a relation with the base point with respect to their composition conditions and attribute values in order to select the four object cells for the diagonal replacing adjustment. However, this selection method is an example and any other methods may be used that allows for the selection of four cells forming the apexes of a given rectangle (parallelogram) in a two-dimensional plane having two composition conditions as the two axes.

The data processing section 20 then manipulates the values of the four cells. First, it determines whether or not the target extraction amount in the base point cell exceeds its extractable amount (step 219 in FIG. 5). If the target extraction amount exceeds the extractable amount, the adjustment direction (increase or decrease) of the target extraction amount at the base point is set in the decreasing direction (step 220). The adjustment amount is the target extraction amount minus the extractable amount.

On the other hand, if the target extraction value in the base point cell does not exceed the extractable value, then it is determined whether the target extraction amount is a negative value or not (step 221). If it is a negative value, the adjustment direction of the target extraction amount at the base point cell is set in the increasing direction (step 222). The adjustment value is the maximum adjustable value, that is the maximum value that can be added to the target extraction amount in the cell opposite the base point or subtracted from the target extraction amount in the other two cells. The target extraction amount in a given cell can be increased to the extent that the target extraction amount does not exceed the extractable amount and can be decreased to the extent that the target extraction amount does not become a negative value.

A target extraction amount becomes negative if the target extraction amount decreases to a value below zero by reducing the target extraction amount in the cell opposite the base point by the same amount as that of the base point.

If it is determined at step 221 that the target extraction amount in the base point cell is more than zero, that is, if the target extraction amount is a value between zero and the extractable amount, then the adjustment amount in the base point cell is calculated as follows:

The adjustment value is a difference between the target extraction amount and zero or a difference between the target extraction amount and the extractable amount. The larger one of the two adjustable values is selected as the adjustment direction and one half of the adjustable value is selected as the adjustment amount (step 223).

The adjustment values set at steps 220 and 222 and the adjustment direction and adjustment amount are just illustrative values. Any other adjustment values may be set that is appropriate for the purpose of adjusting the target extraction amount. In particular, the adjustment direction and amount at step 223 is set in order to make the target extraction amount closer to a proportion of the extractable amount to the population data group. That is, the purpose of the diagonal replacing adjustment, that of reducing the target extraction amount to a value equal to or less than the extractable amount is not impaired even if this adjustment is not performed. Therefore, if it is not required that the component ratio of the attribute values in each composition condition in resulting data be made closer to the proportion of the data in the population data group, the adjustment at the step 223 may be skipped.

After determining the target extraction amount and adjustment direction and amount in the base point cell at steps 220, 222, and 223, the data processing section 20 adjusts the target extraction amounts in the four cells according to the determined adjustment direction. That is, if the adjustment direction of the target extraction amount in the base point cell is in the decreasing direction, a value equivalent to the adjustment amount is subtracted from the target extraction amounts in the base point cell and the cell opposite the base point and the value equivalent to the adjustment amount is added to the target extraction amounts in the other two cells (steps 224, 225).

On the other hand, if the adjustment direction of the target extraction amount in the base point cell is the increasing direction, a value equivalent to the adjustment value is added to the target extraction amount in the base point cell and the cell opposite the base point and the value equivalent to the adjustment amount is subtracted from the target extraction amounts in the other two cells (steps 224, 226).

This operation is described in detail with reference to FIG. 13. Here, a two-dimensional plane (called “plane A2”) having attribute value A2 in composition condition A in the data group shown in FIG. 13 is considered.

First, a cell having an attribute value combination, A2B1C2, is selected as the base point at step 213 of FIG. 4. Then, composition condition B is selected as the first axis at step 214 and a cell having attribute value B3 of composition condition B (that is, a cell having attribute value combination A2B3C2) is selected as an object cell for diagonal replacing adjustment at step 215. Composition condition C is selected as the second axis at step 216 and a cell having attribute value C1 of composition condition C (a cell having attribute value combination A2B1C1) is selected as an object cell for the diagonal replacing adjustment at step 217. Then a cell having attribute value B3 of composition condition B and attribute value C1 of composition condition C (a cell having attribute value combination A2B3C1) is selected as an object cell for the diagonal replacing adjustment at step 218.

The four cells related with one another by two arrows in FIG. 13 are the objects for the diagonal replacing adjustment and a pair of cells pointed by each arrow are the opposing cells.

Then the target extraction amount of the base cell, A2B1C2, is referred to and an adjustment direction and amount are determined. Referring to FIG. 13, the target extraction amount of the cell is 36 and the extractable amount is 0. Therefore, the adjustment direction is set in a direction decreasing the target extraction amount at step 220 and the adjustment value, 36 (=36−0), is set. Because the adjustment direction is the direction decreasing the target extraction amount, 36 is subtracted from the target extraction amount in the base point cell and in its opposing cell and 36 is added to the target extraction amount in the other two cells at step 225.

FIG. 14 shows the association data after the above-described operation. Comparing FIG. 13 with FIG. 14, The target extraction amount in base point cell, A2B1C2, has decreased to zero, which is equal to the extractable amount. The target extraction amount in cell A2B3C1, in the corner opposite the base point has also decreased by 36 to 54. The target extraction amount in cell A2B1C1 has increased by 36 to 72 and that in cell A2B3C2 has increased by 36 to 126. The target extraction amounts in all the cells are in the range from 0 to their extractable amounts.

Then the data processing section 20 transforms the rectangle containing the base point or moves the base point to perform the above-described diagonal replacing adjustment on all the combinations of cells. That is, it is determined whether there is another unprocessed point (cell) in which an attribute value along the second axis selected at step 216 is different from an attribute value in the base point and all the other attribute values that are the same as those in the base point. If there is such a point, the process returns to step 217 of FIG. 4, where the object cell for the diagonal replacing adjustment is selected and the subsequent steps are recursively repeated (step 227 in FIG. 6).

If there is no such a point along the second axis, then it is determined whether or not there is an unprocessed composition condition along an axis other than the second axis that is different from those on the first axis. If there is such a composition condition, the process returns to step 216 of FIG. 4, where a new second axis in the two-dimensional plane is determined and the subsequent steps are recursively repeated (step 228).

If there is no such an unprocessed composition condition, then whether or not there is another unprocessed point (cell) whose attribute value along the first axis selected at step 214 of FIG. 4 is different form an attribute value of the base point and all the other attribute values that are the same as those in the base point. If there is such a point, the process returns to step 215 of FIG. 4, where a new object cell for the diagonal replacing adjustment is selected and the subsequent steps are recursively repeated (step 229, FIG. 6).

If there is no such unprocessed base point along the first axis, then it is determined whether or not there is an unprocessed composition along an axis other than the first axis. If there is such a composition condition, the process returns to step 214 of FIG. 4, where a new first axis in the two-dimensional plan is determined and the subsequent steps are recursively repeated (step 230, FIG. 6). If there is no such an unprocessed point along the first axis, then it is determined whether or not there is a point (cell) that has not been used as the base point. If there is such a point, the process returns to step 213 of FIG. 4, where the point is selected as a new base point and the subsequent process is repeated recursively (step 231, FIG. 6).

Referring to FIG. 14 through FIG. 16, an example of the diagonal replacing adjustment performed by changing the base point and rectangle is described.

In FIG. 14, a cell having an attribute value combination, A2B2C2, is selected as the base point. Then, diagonal replacing adjustment is performed on a rectangle formed by a cells having attribute value combinations B2C1, B2C2 (base point), B3C1, and B3C2 in plane A2 having composition conditions B and C as the orthogonal coordinate axes. Two pairs of cells indicated by two arrows in FIG. 14 are cells in opposing corners.

Referring to cell A2B2C2, which is the base point, the target extraction amount is 54 and extractable amount is zero. Therefore a decreasing direction is selected as the adjustment direction and 54 (=54−0) is used as the adjustment amount. Then 54 is subtracted from the target extraction amount in the base point cell and its opposing cell, and 54 is added to the target extraction amounts in the other two cells.

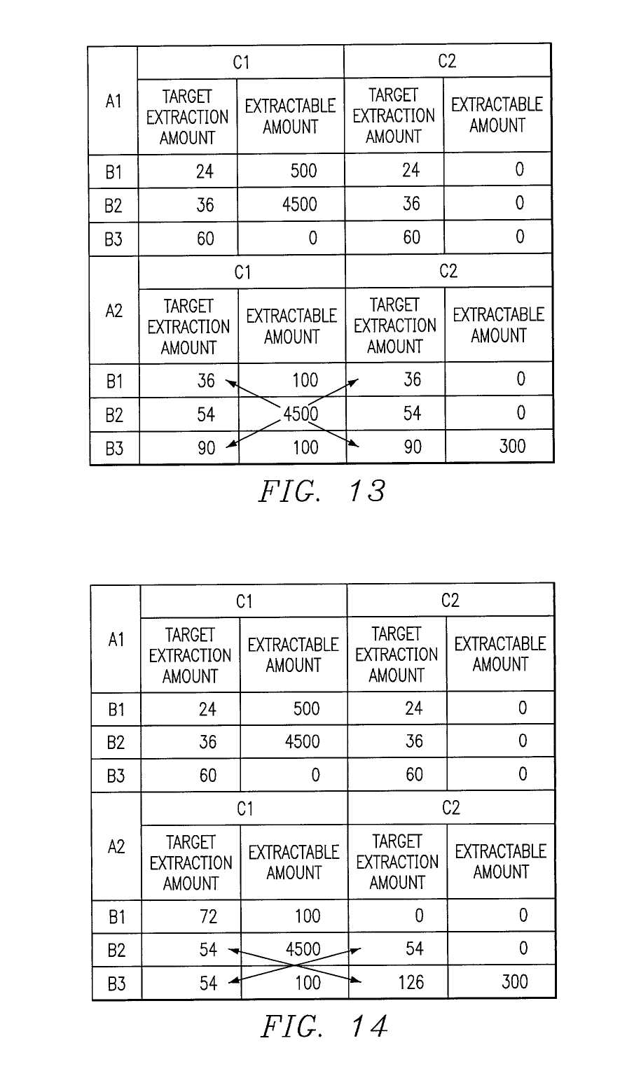

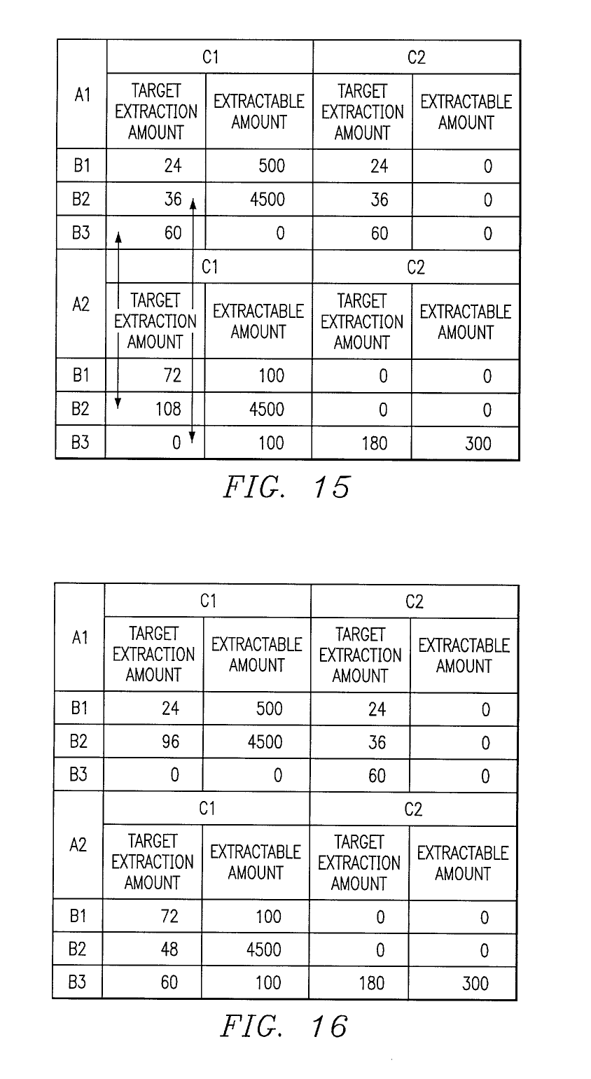

FIG. 15 shows the association data after the above-described operation. Comparing FIG. 14 with FIG. 15, the target extraction amount in base point cell A2B2C2 has decreased by 54 to 0, which is equal to the extractable amount. The target extraction amount in cell A2B3C1 positioned in the corner opposite the base point has also decreased by 54 to 0. The target extraction amount in cell A2B2C1 has increased by 54 to 108 and that in cell A2B3C2 has increased by 54 to 180. The target extraction amount in all of these cells are in the range from 0 to their extractable amount.

Then a cell having an attribute value combination, A1B3C1,is selected as the base point in FIG. 15. In plane C1 with composition conditions A and B as its coordinate axes, diagonal replacing adjustment is performed on a rectangle formed by cells having attribute value combinations, A1B2, A1B3 (base point), A2B2, and A2B3. Two pairs of cells indicated by two arrows in FIG. 15 are cells in opposing corners.

Referring to cell A1B3C1, which is the base point, the target extraction amount is 60 and extractable amount is zero. Therefore a decreasing direction is selected as the adjustment direction and 60 (=60−0) is used as the adjustment amount. Then 60 is subtracted from the target extraction amount in the base point cell and opposing cell, and 60 is added to the target extraction amounts in the other two cells.

FIG. 16 shows the association data after the above-described operation. Comparing FIG. 15 with FIG. 16, the target extraction amount in base point cell A1B3C1 has decreased by 60 to 0, which is equal to the extractable amount. The target extraction amount in cell A2B2C1 positioned in the corner opposite the base point has also decreased by 60 to 48. The target extraction amount in cell A1B2C1 has increased by 60 to 96 and that in cell A2B3C1 has increased by 60 to 60. The target extraction amount in all of these cells are in the range from 0 to their extractable amount.

After performing the diagonal replacing adjustment for all the attribute value combinations in the association data in this way, the data processing section 20 determines, based on the association data for the attribute value combinations in which the results of the diagonal replacing adjustment is reflected, whether or not there is an entry containing a target extraction amount that exceeds its extractable amount (step 232, FIG. 6). If the target extraction amounts in all the entries (step 233) are equal to or less than their extractable amount, the process proceeds to step 235 and the subsequent steps in FIG. 7, where the data is actually extracted from the population data group.

On the other hand, if any of the entries contains a target extraction amount that exceeds its extractable amount, then processing proceeds to step 234. If the diagonal adjustment process has not been performed a predetermined number of times, then the process returns to step 213 of FIG. 4 and the diagonal replacing adjustment is repeated. The replacing adjustment process is repeated until a predetermined number of times is reached. If an entry that contains the target extraction amount exceeding its extractable amount remains after the predetermined number of repetitions (if the data does not converge), it is considered that the data does not converge with the sampling condition. In this case the process, from step 235 in FIG. 7, is performed for extracting the data from the population data group.

FIG. 17 shows association data provided by adding the target extraction amounts, after the diagonal replacing adjustment process shown in FIG. 13 through FIG. 16, to the association data for each attribute value combination shown in FIG. 11. Referring to FIG. 17, entries (for example, the entries of attribute value combinations A1B1C2 and A1B2C2) remain that contain a target extraction amount that exceeds the extractable amount after the diagonal replacing adjustment. Therefore, diagonal replacing adjustment is performed again.

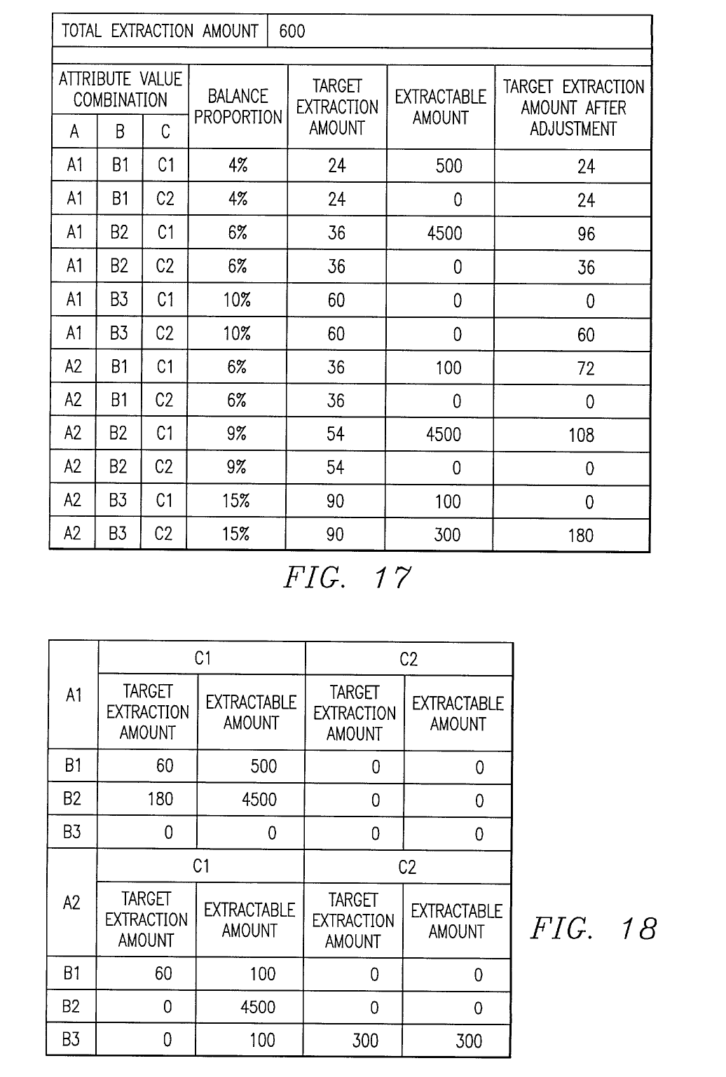

FIG. 18 shows association data after the diagonal replacing adjustment is re-performed. FIG. 19 shows association data provided by adding the target extraction amounts after the diagonal replacing adjustment shown in FIG. 18 to the association data for each attribute value combination shown in FIG. 11.

Referring to FIG. 19, the target extraction amounts, following the adjustment process for all of the entries, are equal to or less than the extractable amounts. Therefore the diagonal replacing adjustment is complete, and the process for extracting the data from the population data group may now proceed.

If, at the decision steps 232 and 234 of FIG. 6, an entry remains in which the target extraction amount exceeds the extractable amount after a predetermined times of diagonal replacing adjustment is performed, an adjustment can be performed for giving priority to the component ratio of attributes in each composition condition input as a sampling condition. That is, a new total extraction amount (step 206, FIG. 2) is calculated by using the equation:

new total extraction amount=previous total extraction amount *(extractable amount/target extraction amount)

In step 203 of FIG. 2, a target extraction amount is recalculated based on the new total extraction amount, and the diagonal replacing adjustment is performed again. By performing the adjustment from setting the total extraction amount, which is a sampling condition, resulting data can be obtained that conforms to the component ratio in each composition condition unless the value of the total extraction amount becomes zero.

Next, the data processing section 20 extracts data that matches each attribute value combination by the target extraction amount form the population data group stored in the sampled population database 60. This data sampling is performed using random numbers. If the database management section 80 cannot sample the data randomly from the population data group, the following procedure is performed to extract the data.

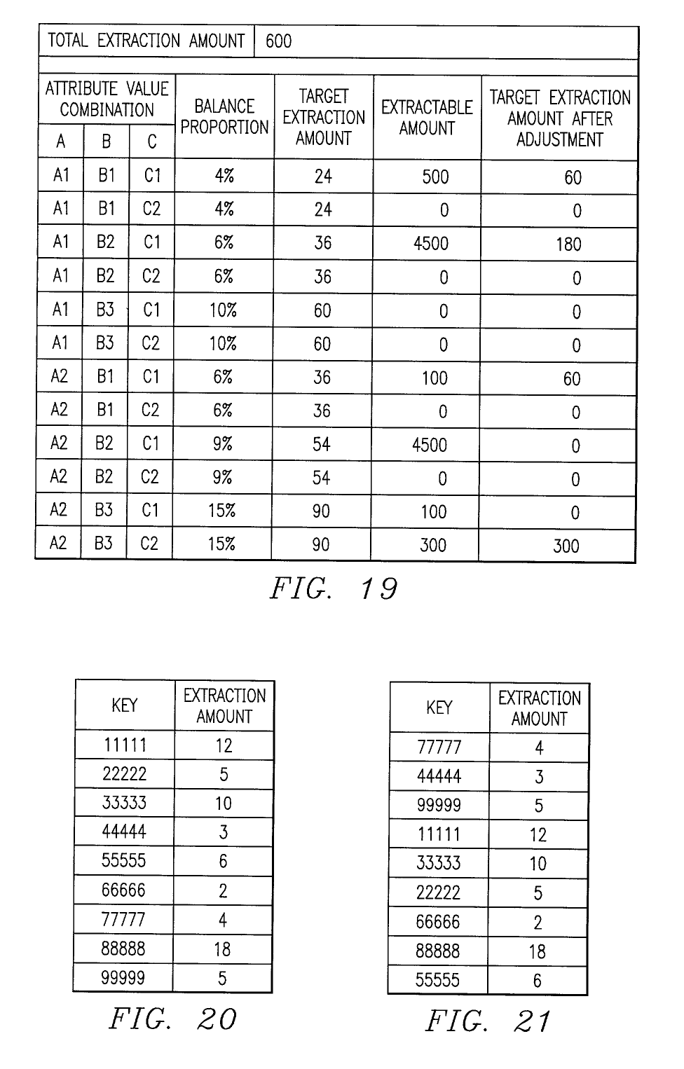

First, an SQL query is issued to the database management section 80 to obtain data in the population data group that matches each attribute value combination (key) and information about the extraction amount (step 235 in FIG. 7). FIG. 20 shows a table listing the key data and extraction amounts obtained in this way. In the example shown, nine keys, 11111 to 99999, are associated with the extraction amounts of data that match these keys. The data are stored in the random-order-key storage 50.

Then the data processing section 20 randomly selects two items of key data from the key data shown in FIG. 20 stored in the random-order-key storage 50 and replaces them with each other (step 236). This operation is repeated a predetermined times to reorder the key data shown in FIG. 20 in a random order (step 237). FIG. 21 shows the list of the randomly ordered key data and extraction amounts generated in this way.

The data processing section 20 extracts the target extraction amount of data and stores the extracted set (resulting data group) into the sampling result database 70 (steps 238, 239). The data sampling is performed by issuing an SQL query to the database management section 80.

The target extraction amount of data corresponding to all the attribute value combinations are randomly extracted and stored in the sampling result database 70 (step 240), and then the data sampling process ends.

The resulting data group obtained in this way is stored in the sampling result database 70. When a data request for obtaining the resulting data group is input from an external source, the data processing section 20 reads the requested resulting data group from the sampling result database 70 through the database management section 80 and outputs it through the output section 90.

The above-described database system may be used for selecting merchandise in securitizing loans. When an entity that wants to merchandise loans held by a financial institution uses the database system to extract a group of loans from the group of loans held by the institution, the entity can specify any proportion of loan attributes and easily create merchandise that includes the loans in that proportion.

As described above, in accordance with the preferred embodiment, purposive sampling may be properly performed to select resulting data wherein target extraction amounts are adjusted with priority to conformance with component ratios, including multidimensional component ratios.

References in the claims to an element in the singular is not intended to mean “one and only” unless explicitly so stated, but rather “one or more.” All structural and functional equivalents to the elements of the above-described exemplary embodiments that are currently known or later come to be known to those of ordinary skill in the art are intended to be encompassed by the present claims. No claim element herein is to be construed under the provisions of 35 U.S.C. 112, sixth paragraph, unless the element is expressly recited using the phrase “means for” or “step for.” While the preferred embodiment of the present invention has been described in detail, it will be understood that modification and adaptations to the embodiments shown may occur to one of ordinary skill in the art without departing from the scope of the present invention as set forth in the following claims. Thus, the scope of this invention is to be construed according to the appended claims and not limited to the specific details disclosed in the exemplary embodiments.

What is claimed is:

1. A data sampling method for extracting, on a computer, a set of data from a population data group, comprising the steps of:
receiving a component ratio for a plurality of attributes associated with a composition condition;
determining an extractable amount for each of said plurality of attributes;
calculating a target extraction amount for each of said plurality of attributes based at least partially on said component ratio; and
if a corresponding target extraction amount for a given attribute, selected from said plurality of attributes, exceeds a corresponding extractable amount for said given attribute, adjusting said corresponding target extraction amount to a value that is equal to or less than said corresponding extractable amount and retaining said component ratio within a predetermined range.

2. The data sampling method according to claim 1 wherein said population data group comprises loan information and said steps further comprise extracting said loan information in accordance with said calculated target extraction amounts whereby a group of loans to be merchandised are identified.

3. A data sampling method for extracting, on a computer system, a set of data from a population data group comprising the steps of:
receiving a component ratio for each of a plurality of composition conditions;
determining an extractable amount for each attribute value combination in said plurality of composition conditions;
calculating a target extraction amount for each attribute value combination; and
adjusting a subset of said target extraction amounts utilizing a diagonal replacing adjustment operation wherein said target extraction amount is less than or equal to said extractable amount for each of said attribute value combinations and said component ratios are retained within a predetermined range.

4. The data sampling method according to claim 3, wherein said plurality of composition conditions form an n-dimensional space and said diagonal replacing adjustment operation is performed on a two-dimensional coordinate plane that cuts through said n-dimensional space.

5. The data sampling method according to claim 4, wherein said diagonal replacing adjustment operation comprises the steps of:
selecting four target extraction amounts from four unique cells within said two-dimensional coordinate plane and designating two of said four target extraction amounts as a first group and designating the remaining two of said four target extraction amounts as a second group;
decreasing each of said two target extraction amounts in said first group by a predetermined value; and
increasing each of said two target extraction amounts in said second group by said predetermined value.

6. The data sampling method according to claim 3 wherein said data sampling method further comprises the step of receiving a sampling condition specifying a total extraction amount and said step of adjusting said subset of target extraction amounts further comprises the step of decreasing said total extraction amount without changing said component ratios.

7. The data sampling method according to claim 3 wherein said population data group comprises loan information and said steps further comprise extracting said loan information in accordance with said calculated target extraction amounts whereby a group of loans to be merchandised are identified.

8. A data manipulation method performed by a data processing apparatus for sampling a population data group with a plurality of composition conditions including a plurality of component ratios, wherein association data, comprising at least a target extraction amount for each attribute value combination in said plurality of composition conditions, are adjusted without changing said plurality component ratios by performing the steps of:
selecting four attributes, two attributes from each of two composition conditions, selected from said plurality of composition conditions, to provide four attribute value combinations of two each of said four attributes;
selecting, from said four attribute value combinations, a first combination having a first attribute and a second attribute;
determining, from said four attribute value combinations, a second combination having a third attribute and a fourth attribute, wherein said third attribute is not equal to said first attribute, said third attribute is not equal to said second attribute, said fourth attribute is not equal to said first attribute, and said fourth attribute is not equal to said second attribute;
decreasing said target extraction amount in said association data for each of said first combination and said second combination by a predetermined value; and
increasing said target extraction amount in said association data for each of a third combination and a fourth combination by said predetermined value, wherein said third combination and said fourth combination comprise the remaining two combinations from said four attribute value combinations after excluding said first combination and said second combination.

9. The data manipulation method according to claim 8, wherein said plurality of composition conditions comprise at least three composition conditions.

10. A database system for extracting data from a population data group according to a predetermined sampling condition, comprising:
a sampled population database storing said population data group;
a sampling condition input section for inputting a data extraction request, said predetermined sampling condition comprising a total extraction amount, a composition condition, and a component ratio of attributes in said composition condition; and
a data processing section for extracting said data from said sampled population database based on said predetermined sampling condition, input through said sampling condition input section, wherein said data processing section:
determines an extractable amount for each of said attributes;
calculates a target extraction amount for each of said attributes based at least partially on said component ratio;
if a corresponding target extraction amount for a given attribute, selected from said attributes, exceeds a corresponding extractable amount for said given attribute, adjusts said corresponding target extraction amount to a value that is equal to or less than said corresponding extractable amount and retains said component ratio within a predetermined range; and
extracts said data from said population data group based at least partially on said adjusted corresponding target extraction amount.

11. The data base system to claim 10 wherein said data base system is used to extract loan information from said population data group, said loan information identifying a group of loans to be merchandised.

12. A database system for extracting data from a population data group according to a predetermined sampling condition, comprising:
a sampled population database storing said population data group;
a sampling condition input section for inputting a data extraction request, said predetermined sampling condition comprising a total extraction amount, a plurality of composition conditions, and a component ratio of attributes in each of said plurality of composition conditions; and
a data processing section for extracting said data from said population database based on said sampling condition, input through said sampling condition input section, wherein said data processing section:
determines an extractable amount for each attribute value combination in said plurality of composition conditions;
calculates a target extraction amount for each attribute value combination in said plurality of composition conditions;
adjusts a subset of said target extraction amounts utilizing a diagonal replacing adjustment operation; and
extracts said data from said population data group based at least partially on said adjusted subset of said target extraction amounts.

13. The data base system according to claim 12, wherein said plurality of composition conditions form an n-dimensional space and said diagonal replacing adjustment operation is performed on a two-dimensional coordinate plane that cuts through said n-dimensional space.

14. The data base system according to claim 13, wherein said diagonal replacing adjustment operation is performed by said data processing section by:
selecting four target extraction amounts from four unique cells within said two-dimensional coordinate plane and designating two of said four target extraction amounts as a first group and designating the remaining two of said four target extraction amounts as a second group;
decreasing each of said two target extraction amounts in said first group by a predetermined value; and
increasing each of said two target extraction amounts in said second group by said predetermined value.

15. The database system according to claim 12 wherein said data processing section decreases said total extraction amount without changing said component ratios in response to adjusting said subset of said target extraction amounts.

16. The database system according to claim 12 wherein said database system is used to extract loan information from said population data group, said loan information identifying a group of loans to be merchandised.

17. An article of manufacture for use in a computer system tangibly embodying computer instructions executable by said computer system for performing process steps, wherein said process steps extract a set of data from a population data group and comprise:
receiving a component ratio for a plurality of attributes associated with a composition condition;
determining an extractable amount for each of said plurality of attributes;
calculating a target extraction amount for each of said plurality of attributes based at least partially on said component ratio; and
if a corresponding target extraction amount for a given attribute, selected from said plurality of attributes, exceeds a corresponding extractable amount for said given attribute, adjusting said corresponding target extraction amount to a value that is equal to or less than said corresponding extractable amount and retaining said component ratio within a predetermined range.

18. The article of manufacture according to claim 17 wherein said population data group comprises loan information and said process steps further comprise extracting said loan information in accordance with said calculated target extraction amounts whereby a group of loans to be merchandised are identified.

19. An article of manufacture for use in a computer system tangibly embodying computer instructions executable by said computer system for performing process steps, wherein said process steps extract a set of data from a population data group and comprise:
receiving a component ratio for each of a plurality of composition conditions;
determining an extractable amount for each attribute value combination in said plurality of composition conditions;
calculating a target extraction amount for each attribute value combination; and
adjusting a subset of said target extraction amounts utilizing a diagonal replacing adjustment operation, wherein said target extraction amount is less than or equal to said extractable amount for each of said attribute value combinations and said component ratios are retained within a predetermined range.

20. The article of manufacture according to claim 19 wherein said plurality of composition conditions form an n-dimensional space and said diagonal replacing adjustment operation is performed on a two-dimensional coordinate plane that cuts through said n-dimensional space.

21. The article of manufacture according to claim 20, wherein said diagonal replacing adjustment operation comprises:
selecting four target extraction amounts from four unique cells within said two-dimensional coordinate plane and designating two of said four target extraction amounts as a first group and designating the remaining two of said four target extraction amounts as a second group;
decreasing each of said two target extraction amounts in said first group by a predetermined value; and
increasing each of said two target extraction amounts in said second group by said predetermined value.

22. The article of manufacture according to claim 19, wherein said process steps further comprise the step of receiving a sampling condition specifying a total extraction amount and said step of adjusting said subset of target extraction amounts further comprises decreasing said total extraction amount without changing said component ratios.

23. The article of manufacture according to claim 19 wherein said population data group comprises loan information and said process steps further comprise extracting said loan information in accordance with said calculated target extraction amounts whereby a group of loans to be merchandised are identified.

24. A method for selecting items of loan information from a population data group residing in a sampled population database wherein said selected items of loan information form a pool of loans to be securitized, said method comprising the steps of:
establishing a credit risk for said pool of loans;
providing a sampling condition comprising multi-dimensional component ratios in accordance with said credit risk and a total extraction amount as the desired number of said items of loan information to form said pool of loans; and
utilizing a diagonal replacing adjustment database system for the selection of said items of loan information whereby said pool of loans is formed in accordance with said credit risk and said pool of loans comprises a number of said items of loan information that is equal to or less than said total extraction amount.
